(19) United States
(12) Patent Application Publication
(10) Pub. No.: US 2004/0247855 A1
(43) Pub. Date: Dec. 9, 2004

(54) Grading porous structure and its process

(75) Inventors: Yoshiaki Kinemuchi, Aichi (JP); Koji Watari, Aichi (JP); Shoji Uchimura, Aichi (JP); Hirohide Ishiguro, Aichi (JP); Hideki Morimitsu, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: National Inst. of Adv. Industrial Sci. and Tech., Tokyo (JP); Sinto V-Cerax, LTD, Toyokawa-shi (JP)

(21) Appl. No.: 10/726,539

(22) Filed: Dec. 4, 2003

(30) Foreign Application Priority Data
Jun. 6, 2003 (JP) 2003-163027

(51) Int. Cl. B32B 3/26

(52) U.S. Cl. 428/310.5

(57) ABSTRACT

It is an object to provide a method of manufacturing a porous medium having a grading porous structure, and there are provided a method of manufacturing a porous medium having a grading porous structure, comprising the steps of installing a sample consisting of a powder compact or a porous body in a rotating body, and heating the sample while applying a centrifugal force to the sample through high-speed rotation of the rotating body to produce a porous medium having a grading porous structure in which the pore size and the porosity change gradually by using the pressure grading in the sample arising through the centrifugal force, and such a method wherein the pore size and the porosity of the sample are predicted based on a linear shrinkage factor calculated through the equation:

linear shrinkage factor=Δl/l₀ (1)

Δl: change in length upon shrinkage

l₀: original length.

and a porous medium having a grading porous structure manufactured using the above method.

### BACKGROUND OF THE INVENTION

1. Field of the Invention

The present invention relates to a method of manufacturing a porous medium in which the porous structure changes gradually, and more particularly to a novel method of manufacturing a porous medium having a grading porous structure that enables the manufacture of a porous medium having a grading porous structure that has a microstructure controlled highly precisely such that the pore size and the porosity change gradually, and to this porous body.

The present invention is useful in the technological field of manufacture of porous media, which are important materials widely used as filters, electrode materials and so on, as an invention providing a novel technique for manufacturing a porous medium having a grading porous structure that enables a desired grading porous structure in which the microstructure of a sample is controlled highly precisely to change in gradated fashion to be designed and manufactured, and can be applied with substantially no limitations on the type of material.

2. Description of the Related Art

Porous media are used widely as filters, electrode materials and so on. It is known that the properties of such a porous medium vary greatly according to the microstructure, specifically the porosity and the pore size, and hence it is necessary to produce a structure suited to the objective. In particular, a porous medium having a grading porous structure in which the pore structure changes gradually is a very useful structure, having advantages such as it being possible to simultaneously satisfy conflicting properties.

With conventional art, in many cases, a porous medium having a layered structure is manufactured by changing the manufacturing conditions in steps; for example, a metal porous body having a gradated structure, a method of manufacturing the same, and a battery substrate using the same have been proposed (see, for example, Japanese Patent Application Laid-open No. 11-176451). However, with this type of method, the manufacturing process is complex, and moreover there is an intrinsic problem that an ideal gradated structure cannot be obtained. There is also a method in which a porous medium is manufactured using anodic oxidation of aluminum; for example, a porous layer, a device, and a method of manufacturing the same have been proposed (see, for example, Japanese Patent Application Laid-open No. 2003-011099).

However, with this type of method, by continuously changing the formation voltage during the anodic oxidation, a porous medium in which the structure changes in gradated fashion can be obtained, but there is a drawback that the material is limited to being aluminum oxide. Moreover, there is also a method in which a gradated structure is manufactured by using a concentration gradient in a slurry drying process; for example, a method of manufacturing a composite reinforcing material for manufacturing a functionally gradated metal-based composite material has been proposed (see, for example, Japanese Patent Application Laid-open No. 07-062470). However, with this type of method, to obtain the desired structure, it is necessary to study in detail the rheology of the slurry, mass transport during the drying, and so on, and hence there is a problem that obtaining the desired structure is extremely difficult in practice.

Amid this state of affairs and in view of the prior art described above, the present inventors carried out assiduous studies with an aim of developing novel art for manufacturing a porous medium having a grading porous structure that enables the various problems of the prior art described above to be thoroughly resolved, and as a result discovered that the intended objective can be obtained by adopting a method in which a powder compact or a porous body is heated while applying a centrifugal force thereto, thus accomplishing the present invention.

### SUMMARY OF THE INVENTION

It is an object of the present invention to provide novel art that enables a porous medium having a desired grading porous structure to be manufactured easily for any of various materials. Furthermore, it is an object of the present invention to provide means for easily determining process parameters for obtaining a desired structure.

To attain the above objects, the present invention is constituted from the following technical means.

(1) A method of producing a porous medium having a grading porous structure, comprising the steps of: installing a sample consisting of a powder compact or a porous body in a rotating body; and heating the sample while applying a centrifugal force to the sample through high-speed rotation of the rotating body to produce a porous medium having a grading porous structure in which the pore size and the porosity change gradually by using the pressure gradient in the sample arising through the centrifugal force.

(2) The method of producing a porous medium having a grading porous structure according to (1) above, wherein the sample is constituted from a material selected from the group consisting of ceramics, metals, plastics, and composite materials thereof.

(3) The method of producing a porous medium having a grading porous structure according to (1) above, wherein the microstructure comprising the pore size and the porosity is controlled by adjusting the pressure gradient in the sample arising through the centrifugal force.

(4) The method of producing a porous medium having a grading porous structure according to (1) above, wherein the porous medium has a bulk form or a membrane form.

(5) The method of producing a porous medium having a grading porous structure according to (1) above, comprising the steps of calculating a shrinkage factor, which is defined as the ratio of an amount of shrinkage to an original size, of the sample due to the pressure arising in the material under the centrifugal force, predicting the pore size and the porosity of the sample and setting producing conditions as process parameters based on the shrinkage factor, and designing and producing a porous medium having a grading porous structure having prescribed pore size and porosity based on the process parameters.

(6) The method of producing a porous medium having a grading porous structure according to (5) above, wherein the pore size and the porosity of the sample are predicted based on a linear shrinkage factor calculated through the equation:

linear shrinkage factor=Δl/l₀ (1)

wherein Δl represents the change in length upon shrinkage, and l₀ represents the original length.

(7) The method of producing a porous medium having a grading porous structure according to (6) above, wherein in the case that sintering proceeds under diffusion control with liquid phase sintering of spherical particles, the pore size and the porosity of the sample are predicted based on a shrinkage factor S(ζᵢ), which is a function of location, calculated through the equation:

$$s = {[ \frac{3 {k}_{2} δ {D}_{L} {C}_{o} {V}_{o}}{{r}_{p}^{3} RT} ( \frac{2 {γ}_{LV}}{{k}_{1} {r}_{p}} + P ) ]}^{\frac{1}{3}} \cdot {t}^{\frac{1}{3}} \qquad ( 5 )$$

wherein k₁ and k₂ represent shape constants, δ represents the thickness of the liquid phase, D_{L} represents the diffusion coefficient in the liquid phase, C₀ represents the amount of dissolution into the liquid phase, V₀ represents the molar volume of the solute, γ_{LV} represents the liquid phase/vapor phase interface surface energy, rₚ represents the initial powder particle size, R represents the gas constant, T represents the absolute temperature, t represents the sintering time, and P represents the centrifugal pressure, which is defined as the pressure arising through the centrifugal force and is a variable of the shape of the sample and the location in the sample.

(8) A porous medium having a grading porous structure produced using the method according to any one of (1) through (7) above, wherein the microstructure comprising the pore size and the porosity have been controlled according to the pressure gradient in the sample arising through the centrifugal force.

(9) The porous medium having a grading porous structure according to (8) above, wherein the porous medium has a bulk form or a membrane form.

(10) A structural component, containing the porous medium having a grading porous structure according to (8) or (9) above as a constituent element thereof.

### BRIEF DESCRIPTION OF THE DRAWINGS

FIG. 1 is a schematic drawing of an apparatus used in the method of the present invention;

FIG. 2 shows sectional photographs of a sample along a direction of centrifugal pressurization (from the left, the surface of the sample (l=0 mm), the center (1 mm), and close to the bottom of the sample (2 mm), with black places in the photographs indicating pores; and

FIG. 3 shows the density distribution along the direction of centrifugal pressurization, with l representing the distance from the surface of the substrate, and ρ representing the density.

### DESCRIPTION OF THE PREFERRED EMBODIMENTS

The present invention will now be described in more detail.

With the present invention, a sample comprising a porous body having uniform pores, a powder compact or the like is heated while applying a centrifugal acceleration thereto, thus manufacturing a porous medium having a grading porous structure having desired pore size and porosity. A centrifugal force gradient arises in the sample, and by using this gradient, it becomes possible to manufacture a porous medium in which the microstructure changes gradually. The centrifugal force can be freely adjusted through the rotational speed of the rotating body, and hence the present invention has the characteristic feature that a gradated structure having desired pore size and porosity can be obtained easily.

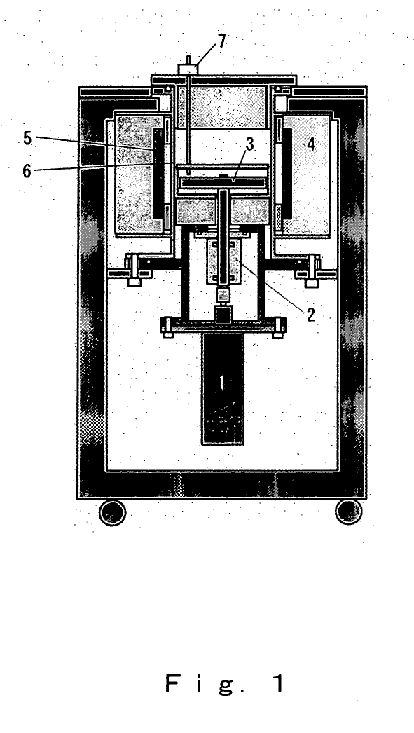

FIG. 1 shows an example of the apparatus used in the method of the present invention. This apparatus is constituted from a rotating body 3, a bearing 2 supporting the rotating body 3, a motor 1, which is a rotation driving source, a heater 5 for heating the sample, a chamber 6, and a temperature measuring part 7. The sample is installed in the rotating body 3, and is subjected to a centrifugal force through rotation of the rotating body 3. The centrifugal force acting on the sample increases with increasing distance from the center of rotation, and hence a pressure gradient arises inside the sample. The pressure promotes sintering, plastic flow (creep) and so on, in other words promotes mass transport and diffusion, and hence the higher the pressure is in a particular location, the higher the relative density will become and the smaller the pore size will become. By heating the sample under the centrifugal force, a porous medium having a grading porous structure can thus be obtained easily. Moreover, this phenomenon occurs with all materials, with there being no limitation on the type of material, and hence the method of the present invention can be applied to various materials with no limitation whatsoever.

Note, however, that the gradated structure changes constantly during the heating period, and hence it is necessary to set suitable conditions for obtaining the desired structure. The basic method of doing this is as follows. As stated above, the pressure arising in the sample under the centrifugal force is a function of location, and hence the shrinkage factor due to the pressure is also a function of location. Here, the shrinkage factor means the ratio of the amount of shrinkage to the original size, and if the shrinkage factor is known, then the porosity and pore size can be predicted. For example, the linear shrinkage factor may be expressed by undermentioned equation (1):

Linear shrinkage factor=Δl/l₀ (1)

Δl: change in length upon shrinkage

l₀: original length.

Here, Δl is the sum over all the parts in the sample of the amount of shrinkage for each part, and hence Δl can be expressed by undermentioned equation (2):

$$\frac{Δ l}{{l}_{o}} = \frac{Δ {l}_{1} + Δ {l}_{2} + … + {Δl}_{i} + … + Δ {l}_{n - 1} + Δ {l}_{n}}{{l}_{o}} \qquad ( 2 )$$

Here, Δlᵢ is the amount of shrinkage for each part of the sample, and this is the product of the shrinkage factor s(ξᵢ) (which is a function of location) and the length Δxᵢ of each part; equation (2) can thus be rewritten as undermentioned equation (3):

$$\begin{matrix}\frac{Δ l}{{l}_{o}} = \frac{1}{{l}_{o}} [ s ( {ξ}_{1} ) Δ {x}_{1} + s ( {ξ}_{2} ) Δ {x}_{2} + … + \\ s ( {ξ}_{i} ) Δ {x}_{i} + … + s ( {ξ}_{n - 1} ) Δ {x}_{n - 1} + s ( {ξ}_{n} ) Δ {x}_{n} ] \\ = \frac{1}{{l}_{o}} {{\sum }_{i}}^{n} s ( {ξ}_{i} ) Δ {x}_{i}\end{matrix} \qquad ( 3 )$$

Taking the Δxᵢ's to be infinitesimal, equation (3) becomes undermentioned equation (4):

$$\frac{Δ l}{{l}_{o}} = \frac{1}{{l}_{o}} {\int }_{{l}_{o}} s ( {ξ}_{i} ) ⅆ x \qquad ( 4 )$$

and this is the expression for the shrinkage factor under the centrifugal force. Here, the range of integration is taken to be the whole of the sample, and hence the equation expresses the shrinkage factor for the whole of the sample. To obtain the shrinkage factor for a particular portion, the range of integration should be made to correspond to this portion. Moreover, the shrinkage factor s(ξᵢ) should be selected as appropriate in accordance with the mechanism that determines the rate of shrinkage for the material in question. For example, in the case that sintering proceeds under diffusion control with liquid phase sintering of spherical particles, s(ξᵢ) is as in undermentioned equation (5).

$$s = {[ \frac{3 {k}_{2} δ {D}_{L} {C}_{o} {V}_{o}}{{r}_{p}^{3} RT} ( \frac{2 {γ}_{LV}}{{k}_{1} {r}_{p}} + P ) ]}^{\frac{1}{3}} \cdot {t}^{\frac{1}{3}} \qquad ( 5 )$$

k₁, k₂: shape constants

δ: thickness of liquid phase

D_{L}: diffusion coefficient in liquid phase

C₀: amount of dissolution into liquid phase

V₀: molar volume of solute

γ_{LV}: liquid phase/vapor phase interface surface energy

rₚ: initial powder particle size

R: gas constant

T: absolute temperature

t: sintering time

P: centrifugal pressure

Here, the centrifugal pressure is defined as the pressure arising through the centrifugal force, and is a variable of the shape of the sample and the location in the sample.

For example, with liquid phase sintering, in the case that the dissolution/reprecipitation process determines the rate of sintering, the manufacturing conditions for obtaining a desired structure can be determined using the above relationship. In the case that another process determines the rate of sintering (particle rearrangement mechanism, solid phase diffusion, creep, etc.), quantification of the structure can be made possible by substituting the effect of applied pressure with this mechanism into equation (4).

The process of the present invention can be applied to a structure having a bulk form or a membrane form, and can be applied to systems in which mass transport is affected by applied pressure (which substantially applies to all materials). In the case of applying the present invention to a composite material, it is necessary to pay attention to the difference in specific gravity between the matrix material and the dispersed material. Specifically, in the case of applying a high centrifugal force, plastic deformation becomes rate-determining, and hence the substance having the lower specific gravity will become segregated toward the side closer to the center of rotation. In the case of intentionally seeking such gradation in the composition, this is fine as is, but in the case of wishing to obtain a uniform composition, the pressure should be reduced (i.e. the rotational speed should be reduced) so that the manufacture is carried out under conditions under which plastic deformation is not rate-determining.

With the method of the present invention, preferable examples of powder compacts include pressed compacts, sheet-formed compacts, and extrusion-molded compacts. Moreover, preferable examples of porous bodies include porous bodies having uniform pores obtained by degreasing one of the above compacts, mesoporous bodies, and macroporous bodies, although there is no limitation thereto. As the rotating body, for example a suitable rotating body installed so as to be rotatable by the rotational driving force of a motor can be used. The powder compact or porous body is installed in a suitable position in the rotating body, and the rotating body is rotated at high speed, whereby a prescribed centrifugal force is applied to the powder compact or porous body. At this time, 500 to 100,000 rpm is suitable as the rotational speed of the rotating body, and 0.1 to 100 MPa is suitable as the centrifugal force. However, there is no limitation thereto with the present invention.

With the present invention, the powder compact or porous body is heated (sintered) under the centrifugal force; regarding the heating conditions at this time, 0.5 to 0.9TM is suitable. Moreover, examples of the heating method include resistive heating, inductive heating, microwave heating, infrared heating, and laser heating. However, there is no limitation thereto with the present invention.

With the present invention, the pore size and porosity of the sample can be controlled by suitably adjusting conditions such as the type and composition of the powder compact or porous body, the rotational speed of the rotating body, the centrifugal force, the heating temperature, the heating rate and the heating time based on sintering kinetics theory. With the method of the present invention, preferably, for example, ceramics (e.g. SiC, Al₂O₃, mullite, Si₃N₄, barium titanate, ZrO₂, etc.), metals (e.g. SUS, copper, aluminum, nickel, silver, palladium, etc.) orplastics (e.g. polystyrene, an acrylic, polyethylene, polypropylene, an epoxy polyimide, etc.) are used as raw materials, and, for example, various powders are mixed together in a suitable composition, a paste is prepared, and screen printing is carried out to produce a membrane, whereby a powder compact or porous body is prepared, and then the material is processed using the method of the present invention, whereby a porous medium having a grading porous structure suitable for a gas separation membrane, a DPF, an electrode material or the like can be manufactured; however, there is no limitation thereto.

With the present invention, a porous body having a bulk form or membrane form can be manufactured. The former can be manufactured by processing the sample using, for example, powder pressing, extrusion molding, slip casting, or injection molding. Moreover, the latter can be manufactured by processing the sample using, for example, screen printing, extrusion molding, or slip casting.

With the present invention, the shrinkage factor (the ratio of the amount of shrinkage to the original size) due to pressure arising in the material under the centrifugal force is calculated, and the pore size and the porosity of the sample are predicted and manufacturing conditions are set as process parameters based on the shrinkage factor, and then porous medium having a grading porous structure having prescribed pore size and porosity can be designed and manufactured based on the process parameters. For example, the pore size and the porosity can be predicted based on the linear shrinkage factor as calculated using previously mentioned equation (1)

Moreover, for example, in the case that sintering proceeds under diffusion control with liquid phase sintering of spherical particles, the pore size and the porosity of the sample can be predicted based on the shrinkage factor as calculated using previously mentioned equation (5). Manufacturing conditions are then set based on the predictions, and then a porous medium having a grading porous structure having desired pore size and porosity can be designed and manufactured based on these manufacturing conditions.

According to such a method, a porous medium having a grading porous structure wherein the microstructure comprising the pore size and the porosity have been highly precisely controlled according to the pressure gradient in the sample arising through the centrifugal force can be obtained. The microstructure comprising the pore size and the porosity may be freely designed in accordance with the usage objective. According to the present invention, any of various structural components such as a filter, an electrode material or a heat insulating material containing a porous medium having a grading porous structure as described above as a constituent element thereof can be provided.

### EXAMPLES

Next, a concrete description of the present invention will be given through examples; however, the present invention is not limited by the following examples whatsoever.

### Example 1

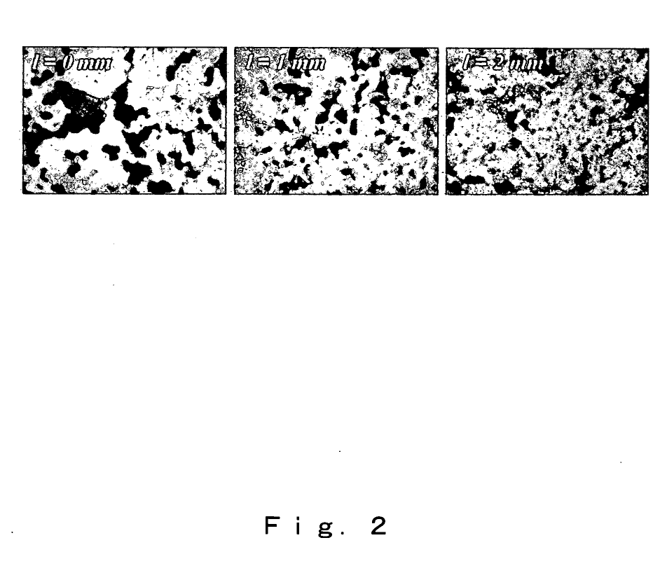

Boric acid (H₃BO₃, 16 mass %) and sodium (Na₂SiO₃, 3.9 mass %) were added as auxiliaries to an SiO₂ powder, and a powder compact (diameter 10 mm×thickness 4 mm, 2 g) was manufactured by pressing. The compact was heated to 800° C. while applying a centrifugal acceleration of 84 km/s², and was held in this state for 1,000 minutes, and then the compact was cooled, whereby a porous medium having a grading porous structure was obtained. FIG. 2 shows sectional photographs thereof. In FIG. 2, l represents the distance from the surface of the sample (at this surface, hardly any centrifugal force acts). In the photographs, black places indicate pores. It can be seen that a pore structure in which the porosity and the pore size change gradually could be produced.

### Example 2

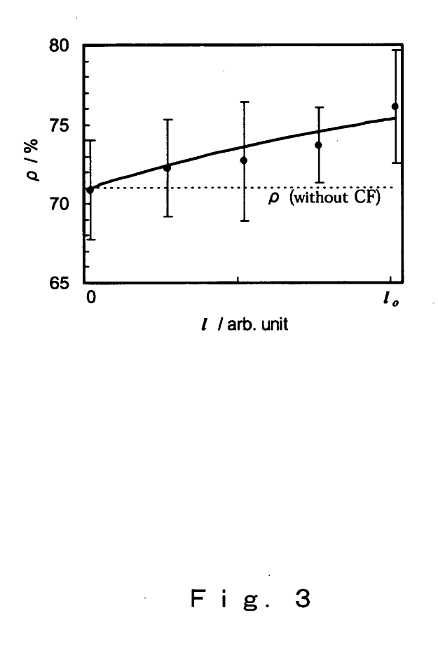

A sample was manufactured under the same conditions as in Example 1, and the location dependence of the density of the sample was measured. The results are shown in FIG. 3. In FIG. 3, l represents the distance from the surface of the sample (at this surface, hardly any centrifugal force acts), and ρ represents the relative density (={sample density}/{theoretical density}) at each location. Here, the density at each location was measured using image analysis. It can be seen that the density gradually increases with increasing distance from the surface. Moreover, the porosity is (1−(relative density)), and hence the results show that the porosity gradually drops with increasing distance from the surface.

### Example 3

The pore structure formed in the sample was predicted based on the above implemented conditions using a calculation. The results of the calculation are shown as a full line in FIG. 3. The calculated values and the actual structure agree extremely well. It can thus be seen that the pore structure can be predicted in advance, and a desired pore structure can be obtained through the method of the present invention.

As described in detail above, by using the present invention, the following effects are achieved: 1) a porous medium having a grading porous structure can be manufactured easily; 2) the method of the present invention can, in principle, be applied to all materials; 3) the grading porous structure can be freely controlled by changing the rotational speed; 4) the pore structure obtained can be predicted in advance, and hence the conditions for obtaining a desired pore structure can be determined in advance; 5) the porosity and pore size can be predicted based on the shrinkage factor, and hence a desired pore structure can be produced.

What is claimed is:

1. A method of producing a porous medium having a grading porous structure, comprising the steps of:
installing a sample consisting of a powder compact or a porous body in a rotating body; and
heating the sample while applying a centrifugal force to the sample through high-speed rotation of the rotating body to produce a porous medium having a grading porous structure in which the pore size and the porosity change gradually by using the pressure gradient in the sample arising through the centrifugal force.

2. The method of producing a porous medium having a grading porous structure according to claim 1, wherein the sample is constituted from a material selected from the group consisting of ceramics, metals, plastics, and composite materials thereof.

3. The method of producing a porous medium having a grading porous structure according to claim 1, wherein the microstructure comprising the pore size and the porosity is controlled by adjusting the pressure gradient in the sample arising through the centrifugal force.

4. The method of producing a porous medium having a grading porous structure according to claim 1, wherein the porous medium has a bulk form or a membrane form.

5. The method of producing a porous medium having a grading porous structure according to claim 1, comprising the steps of:
calculating a shrinkage factor, which is defined as the ratio of an amount of shrinkage to an original size, of the sample due to the pressure arising in the material under the centrifugal force;
predicting the pore size and setting the porosity of the sample and producing conditions as process parameters, based on the shrinkage factor; and
designing and producing a porous medium having a grading porous structure having prescribed pore size and porosity, based on the process parameters.

6. The method of producing a porous medium having a grading porous structure according to claim 5, wherein the pore size and the porosity of the sample are predicted based on a linear shrinkage factor calculated through the equation:
linear shrinkage factor=Δl/l₀ (1)
wherein Δl represents the change in length upon shrinkage, and l₀ represents the original length.

7. The method of producing a porous medium having a grading porous structure according to claim 6, wherein in the case that sintering proceeds under diffusion control with liquid phase sintering of spherical particles, the pore size and the porosity of the sample are predicted based on a shrinkage factor S(ζᵢ), which is a function of location, calculated through the equation:
$$s = {[ \frac{3 {k}_{2} δ {D}_{L} {C}_{o} {V}_{o}}{{r}_{p}^{3} RT} ( \frac{2 {γ}_{LV}}{{k}_{1} {r}_{p}} + P ) ]}^{\frac{1}{3}} \cdot {t}^{\frac{1}{3}} \qquad ( 5 )$$
wherein k₁ and k₂ represent shape constants, δ represents the thickness of the liquid phase, D_{L} represents the diffusion coefficient in the liquid phase, C₀ represents the amount of dissolution into the liquid phase, V₀ represents the molar volume of the solute, γ_{LV} represents the liquid phase/vapor phase interface surface energy, rₚ represents the initial powder particle size, R represents the gas constant, T represents the absolute temperature, t represents the sintering time, and P represents the centrifugal pressure, which is defined as the pressure arising through the centrifugal force and is a variable of the shape of the sample and the location in the sample.

8. A porous medium having a grading porous structure produced using the method according to any one of claims 1 through 7, wherein the microstructure comprising the pore size and the porosity have been controlled according to the pressure gradient in the sample arising through the centrifugal force.

9. The porous medium having a grading porous structure according to claim 8, wherein the porous medium has a bulk form or a membrane form.

10. A structural component, containing the porous medium having a grading porous structure according to claim 8 or 9 as a constituent element thereof.
